(19) United States
(12) Patent Application Publication
(10) Pub. No.: US 2007/0092749 A1
(43) Pub. Date: Apr. 26, 2007

(54) Method for producing a sliding surface

(76) Inventors: Axel Heuberger, Wildberg (DE); Patrick Izquierdo, Ulm (DE); Alexander Sagel, Lenningen (DE); John Schmid, Bad Wildbad (DE); Christian Wanke, Ostfildern (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/547,208

(22) PCT Filed: Feb. 16, 2004
(86) PCT No.: PCT/DE04/00282

§ 371 Date: Jun. 29, 2006

(30) Foreign Application Priority Data
Feb. 27, 2003 (DE) 103 08 422.3

(51) Int. Cl. B05D 1/08; C23C 4/00; F02F 1/00; B23P 9/00

(52) U.S. Cl. 428/553; 427/446; 123/193.2; 428/687

(57) ABSTRACT

The invention relates to a sliding surface (1), which is applied by arc spraying with the aid of a rotating tool. During the spraying process, the parameters are to be set in such a way that all the material particles are fused. The benefit of the high degree of fusion is that the sliding surface (1) can be machined by precision turning without the uncontrolled eruption of material. The rotating spraying process orientates the surface roughness on the face (1.2) of the sliding surface (1) transversally in the peripheral direction. This enables valley structures in the form of recesses (1.1) to be produced during the precision turning process, said recesses having a Peklenit factor of less than 1, achieving a high degree of flow obstruction and forming a defined oil-retaining volume.

### BACKGROUND OF THE INVENTION

1. Field of the Invention

The invention relates to the method for producing a cylindrical sliding surface with a bearing axis by arc spraying of material particles of an Fe-based alloy.

2. Related Art of the Invention

A method for producing a sliding surface is already known from DE 195 49 403 A1. The sliding surface is produced by thermal spraying of a coating comprising steel together with molybdenum. In this method, a mixture of 20-60% molybdenum powder and 80-40% steel powder is sprayed on to the aluminum alloy to form the coating which has the sliding surface. A similar method for producing a sliding surface as well as the sliding surface itself are known from U.S. Pat. No. 6,095,107 A and DE 100 54 015 A1. Properties of iron alloys which are applied by arc spraying are disclosed in [Levchenko et al., “Structure and properties of arc sprayed steel-molybdenum coatings”; STEEL in the USSR., Metals Society, London, GB, Vol. 17, No. 3, 1 Mar. 1987].

### SUMMARY OF THE INVENTION

The invention is based on the object of forming and building up a sliding surface in such a manner as to produce a roughness distribution which is advantageous for the build-up of pressure.

The object is achieved, according to the invention, by virtue of the fact that the sliding surface is applied by a rotating spraying tool, and the microstructure of the sliding surface is oriented in the circumferential direction or is oriented so as to deviate by at most 45° from the circumferential direction with respect to the bearing axis. As a result, a transverse orientation of the roughness of the sliding surface is created, which has a beneficial effect on the formation of hydrodynamic pressure.

For this purpose, it is advantageous if 95 to 100% of all the material particles to be sprayed are melted, and after the spraying operation recesses or valley structures are produced in the sliding surface and/or on the surface by precision turning. The arc spraying method is controlled in such a manner that all the material particles are melted. During the precision-turning, on account of the high degree of melting of the material particles, valley structures in the form of recesses are produced and uncontrolled layer flaking of material particles which have not been melted is avoided.

Consequently, a defined surface topography predominantly made up of valley structures is produced when the sliding surface is being sprayed on. This surface topography is defined by an increased roughness of the surface and a defined orientation. During precision-turning to a defined diameter, the surface roughness is not completely abraided. A certain residual roughness, which is oriented in the circumferential direction and forms a defined oil reservoir, remains.

According to a refinement, an additional option is that the sliding surface and the recesses, after the precision-turning operation, are machined by a microfinishing process, such as, for example ceramfinishing. This allows the degree of residual roughness and therefore the oil reservoir to be set deliberately and reproducibly. The uniform distribution of the oil reservoir over the surface of the sliding surface is important in this context.

Furthermore, the invention relates to a sliding surface of a bearing which is applied to a support surface by arc spraying, with the sliding surface being formed from an Fe-based alloy.

With a view of achieving a roughness distribution which is advantageous for the build-up of pressure, it is provided, according to the invention, that the sliding surface, in the region of a surface has a valley structure formed from recesses, the recesses forming a flow obstacle and having an orientation with respect to a bearing axis which deviates by at most 45° from the circumferential direction. The valley structure or the recesses therefore run transversely with respect to the running direction of the sliding bearing and are randomly oriented. As a result, the build-up of hydrodynamic pressure is improved and the coefficient of the friction is reduced.

For this purpose, it is advantageous for the recesses to form an oil-holding volume which amounts to between 0.01 and 2 mm³ in particular between 0.04 and 0.1 mm³, per cm² of surface. The oil-holding volume, which can be set quantitatively uniformly over the entire sliding surface, forms the sliding lubrication and reduces the wear to the running partners. The oil-holding volume is determined at a lubrication film thickness of 0. However, there is no deformation of the roughness peaks during the determination. Only the oil-holding volume in combination with the alignment or orientation of the recesses leads to an increased flow obstacle.

Finally, according to a preferred embodiment of the solution according to the invention, it is provided that the extent of the flow obstacle formed by the surface has a mean Peklenit factor of less than 1, this factor indicating the orientation of the recesses as the ratio of correlation lengths of the recesses in the running direction perpendicular to the running direction. The correlation lengths are the lengths in the running direction and the lengths perpendicular to the running direction. The factor 1 describes an isotropic orientation of the recesses, and the factor <1 describes a transverse orientation of the recesses.

It is particularly important for the present invention that the sliding surface is formed from a molybdenum-free Fe-based alloy and/or is formed from an Fe-based alloy which contains between 0.8 and 0.9% of carbon. Further alloying constituents are not required, on account of the high pressure which is formed and the good lubrication properties.

In connection with the design and arrangement according to the invention, it is advantageous if the sliding surface has a roughness of between 0.1 and 0.5 mm following the spraying and precision-turning operations. This degree of roughness, in combination with a defined orientation, has proven highly advantageous with a view to further machining. The degree of surface roughness is not completely removed during the precision-turning.

It is correspondingly advantageous if the sliding surface has a roughness value of between 0.01 and 0.03 mm following the spraying and precision-turning operations. The roughness value is the crucial factor for the oil-holding volume. The precision-turning determines the value of the residual roughness in correlation with the required bearing internal diameter.

Moreover, it is advantageous if the sliding surface is designed as a running sleeve for a piston of an internal combustion engine, and the support surface forms a cylinder wall of a cylinder casing. The recesses extend perpendicular to the running direction of the piston. The corresponding flow obstacle is dependent on the orientation and length of the recesses. Long recesses oriented substantially in the circumferential direction form a very good flow obstacle. Very good sliding properties are produced in combination with the oil-holding volume.

A further possible way of improving the tribological properties of the running sleeve is produced by what is known as delayed-action combustion. As a result of a special combustion sequence being set for a brief period of time, combustion reaction products are accumulated. These reaction products predominantly comprise carbon and a small amount of additive residues. The carbon in this case has a positive influence on the susceptibility of the running partners to seizing, since it acts as a solid lubricant. This method allows a molybdenum-free Fe-based alloy to be used as sliding surface.

Si, Cr, Ni, Cu or Mg is added as an alloying constituent to the Fe-based alloy in order to further improve the tribological properties.

### BRIEF DESCRIPTION OF THE DRAWINGS

Further advantages and details of the invention are explained in the patent claims and in the description and are illustrated in the figures, in which:

FIG. 1 shows a diagrammatic cross section through a sliding surface following the spraying operation;

FIG. 2 shows a diagrammatic cross section through a sliding surface following the precision-turning operation;

FIG. 3 diagrammatically depicts the structure of a sliding surface.

### DETAILED DESCRIPTION OF THE INVENTION

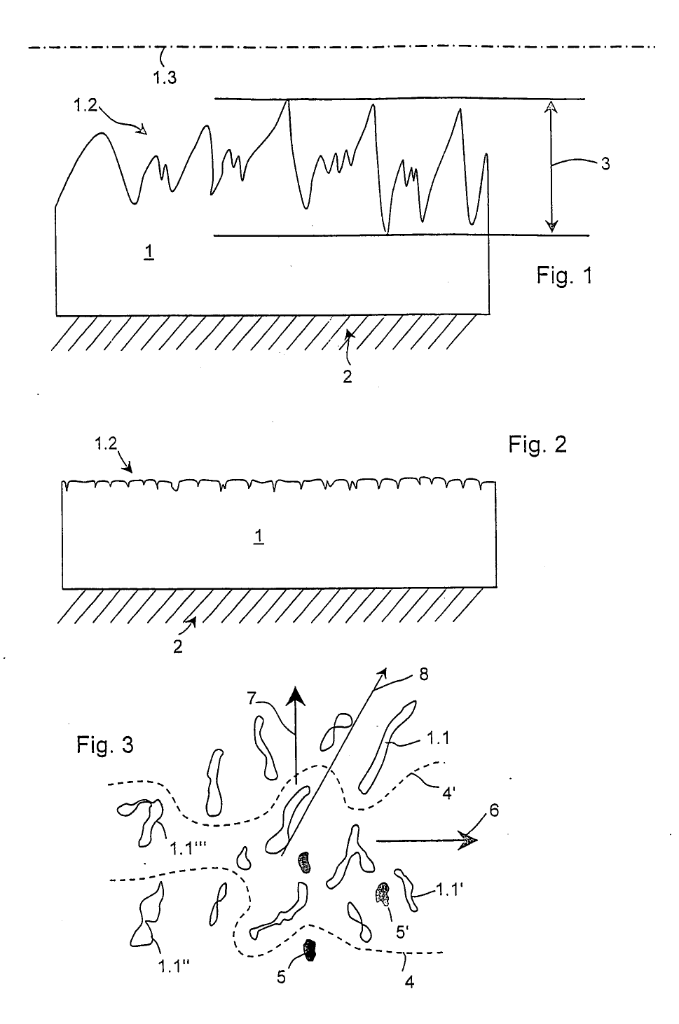

In accordance with FIG. 1, the sliding surface 1 has been sprayed onto a support surface 2. The support surface 2 forms a hollow cylinder with a bearing axis 1.3. The degree of roughness of the surface 1.2 amounts to at most 0.5 mm. The roughness is defined as the difference between the largest and smallest distance from the surface 1.2 to the bearing axis 1.3. The ratio of the absolute layer thickness of the sliding surface 1 to the degree of roughness 3 is not to scale in this illustration.

FIG. 2 shows the sliding surface 1 following the precision-turning of the surface 1.2. The precision-turning smoothes the roughness peaks. A certain residual roughness, which forms an oil reservoir, remains. FIGS. 1 and 2 are not to scale with respect to one another.

The spraying process by means of a burner which rotates in the circumferential direction 7 and the melting of all the material particles results in the production of a topography as shown in FIG. 3 on the surface 1.2. FIG. 3 shows a sliding surface 1 designed as a running sleeve for a piston of an internal combustion engine. The running direction 6 of the piston is indicated by an arrow.

The surface 1.2 predominantly comprises recesses 1.1, 1.1′, 1.1″, 1.1′″, which form a valley structure. The orientation 8 produced by means of the procedure used in the arc spraying process is such that additional flow obstacles 4, 4′ are produced in the piston running direction. Ideally, the recesses 1.1 are oriented in the circumferential direction 7. In the present example, the orientation 8 deviates from the circumferential direction 7 by approx. 35°.

In addition to the recesses 1.1, solid lubrication islands 5, 5′ in the form of particles have been introduced into the sliding surface 1 and form a basic load-bearing capacity for the tribological system.

The orientation of the surface roughnesses described above has an advantageous effect on the formation of hydrodynamic pressure. As a result, the load-bearing capacity of the tribological system can be increased further by increasing the lubricating film thickness of the sliding surface 1. The overall surface topography can be formed in such a way as to establish a peklenit factor of less than 1.

### List of designations

1 Sliding surface
1.1 Recess, valley structure
1.1′ Recess, valley structure
1.1″ Recess, valley structure
1.1′″ Recess, valley structure
1.2 Surface
1.3 Bearing axis
2 Support surface
3 Degree of roughness
4 Flow obstacle
4′ Flow obstacle
5 Solid lubricant island
5′ Solid lubricant island
6 Running direction
7 Circumferential direction
8 Orientation

1. A method for producing a cylindrical sliding surface (1) with a bearing axis (1.3) by arc spraying of material particles of an Fe-based alloy, wherein
the sliding surface (1) is applied by a rotating spraying tool, and
the microstructure of the sliding surface (1) is oriented in the circumferential direction (7) or is oriented so as to deviate by at most 45° from the circumferential direction (7) with respect to the bearing axis (1.3).

2. The method as claimed in claim 1, wherein 95 to 100% of all the material particles to be sprayed are melted, and after the spraying operation recesses (1.1) or valley structures are produced in the sliding surface (1) and/or on the surface (1.2) by precision turning.

3. The method as claimed in claim 1, wherein the sliding surface (1) and the recesses (1.1), after the precision-turning operation, are machined by a microfinishing process, such as, for example ceramfinishing.

4. A sliding surface (1) of a bearing, which has been applied by arc spraying to a support surface (2), the sliding surface (1) being formed from an Fe-based alloy, wherein
the sliding surface (1), in the region of a surface (1.2) has a valley structure formed from recesses (1.1),
the recesses (1.1) forming a flow obstacle (4) and having an orientation (8) with respect to a bearing axis (1.3) which deviates by at most 45° from the circumferential direction (7).

5. The sliding surface (1) of a bearing as claimed in claim 4, wherein the recesses (1.1) form an oil-holding volume which amounts to between 0.01 and 2 mm³ per cm² of surface (1.2).

6. The sliding surface (1) of a bearing as claimed in claim 4, wherein the extent of the flow obstacle (4) formed by the surface (1.2) of the sliding surface (1) has a mean Peklenit factor of less than 1.

7. The sliding surface (1) of a bearing as claimed in claim 4, wherein the sliding surface (1) is formed from a molybdenum-free Fe-based alloy and/or is formed from an Fe-based alloy which contains between 0.8 and 0.9% of carbon.

8. The sliding surface (1) of a bearing as claimed in claim 4 wherein the sliding surface (1) has a roughness of between 0.1 and 0.5 mm following the spraying and precision-turning operations.

9. The sliding surface (1) of a bearing as claimed in claim 4, wherein the sliding surface (1) has a roughness value of between 0.01 and 0.03 mm following the spraying and precision-turning operations.

10. The sliding surface (1) of a bearing as claimed in claim 4, wherein the sliding surface (1) is designed as a running sleeve for a piston of an internal combustion engine, and the support surface (2) forms a cylinder wall of a cylinder casing.
